(19) United States
(12) Patent Application Publication
(10) Pub. No.: US 2023/0365462 A1
(43) Pub. Date: Nov. 16, 2023

(54) GLASS, GLASS-CERAMIC, AND CERAMIC ARTICLES WITH AN EASY-TO-CLEAN COATING AND METHODS OF MAKING THE SAME

(71) Applicant: Corning Incorporated, Corning, NY (US)

(72) Inventors: Kaveh Adib, Corning, NY (US); Robert Alan Bellman, Ithaca, NY (US); Philip Simon Brown, Big Flats, NY (US); Theresa Chang, Painted Post, NY (US); Ying Wei, Painted Post, NY (US); Shu Yuan, Horseheads, NY (US)

(21) Appl. No.: 18/027,462

(22) PCT Filed: Sep. 10, 2021
(86) PCT No.: PCT/US2021/049800

§ 371 Date: Mar. 21, 2023

Related U.S. Application Data
(60) Provisional application No. 63/083,328, filed on Sep. 25, 2020.

(51) Int. Cl. C03C 17/42; C09D 5/00; C09D 183/16; C09D 183/04

(52) U.S. Cl. CPC C03C 17/42; C09D 5/006; C09D 183/16; C09D 183/04; C03C 2217/73; C03C 2217/76; C03C 2217/78

(57) ABSTRACT

An article and method of manufacturing an article is provided. The article includes a glass, glass-ceramic, or ceramic substrate having a primary surface with an anti-reflective coating disposed over the primary surface. An intermediate coating containing a cured polysilazane or a cured silsesquioxane material is disposed over the anti-reflective coating. An easy-to-clean (ETC) coating containing a polymer and/or fluorinated material is disposed directly on the intermediate coating. The method of manufacturing the article includes curing an intermediate coating solution containing a polysilazane or a silsesquioxane to form an intermediate coating at a temperature of about 300° C. or less.

This application claims the benefit of priority under 35 U.S.C. § 119 of U.S. Provisional Application Ser. No. 63/083,328 filed on Sep. 25, 2020, the content of which is relied upon and incorporated herein by reference in its entirety.

### FIELD

The present disclosure generally relates to glass, glass-ceramic, and ceramic articles having an easy-to-clean (ETC) coating, and methods of making the same.

### BACKGROUND

Glass, glass-ceramic, and ceramic materials are prevalent in various displays and display devices of many consumer electronic products. For example, chemically strengthened glass is favored for many touch-screen products, including cell phones, music players, e-book readers, notepads, tablets, laptop computers, automatic teller machines, and other similar devices. Many of these glass, glass-ceramic, and ceramic materials are also employed in displays and display devices of consumer electronic products that do not have touch-screen capability, but are prone to direct human contact, including desktop computers, laptop computers, elevator screens, equipment displays, and others.

The glass, glass-ceramic, and ceramic materials are often treated to provide desired aesthetic and functionality characteristics based on the end-use application of the material. For example, anti-reflective, anti-glare, and anti-fingerprint treatments are common treatments used on materials used in touch-screen products. Touch-screen products used in automotive applications often have longer application lifetimes than other types of devices, such as handheld devices (e.g., cell phone, tablet, e-book reader, etc.). Therefore, the durability requirements for treatments applied to glass, glass-ceramic, and ceramic materials intended for use in automotive applications may be higher than other types of applications.

The desired durability of some types of treatments, such as an anti-fingerprint coating, can be difficult to achieve in combination with other treatments, such as an anti-reflective coating. Material choices for anti-fingerprint treatments, also referred to as easy-to-clean (ETC) treatments, typically rely on the ability of the treatment materials to repel material from the surface, such as water, dust, and environmental debris including sebum, oils, and proteins, for example. The ETC treatment can experience wear over time, such as from repeated touching, swiping, cleaning, etc. during use that can affect the ability of the surface of the ETC treatment to maintain the ability to repel material from the surface. One example of an ETC treatment includes fluorinated materials with silane moieties. The fluorinated silanes can bind to the surface as a monolayer or multilayer, depending on the coating treatment and surface chemistry. For example, fluoroether silane, a material often used to form ETC coatings, typically forms a coating on glass having a thickness of about 2 nm to 5 nm. Once this nanoscale ETC coating is abraded away, the surface no longer exhibits the desired repellant properties.

One conventional method used to improve the durability and adhesion of an ETC coating is roughening of the underlying surface upon which the ETC coating is applied. However, the use of mechanical roughening and/or chemical agents or treatments to facilitate adhesion and/or improve durability of the ETC coating can often affect the optical characteristics of the underlying glass, glass-ceramic, and ceramic substrate. For example, the roughening and/or chemical agents or treatments may decrease the transparency and/or increase the haze of the glass, glass-ceramic, and ceramic substrate, which may not be desirable in some applications. In some cases, the roughening and/or chemical agents or treatments may also undesirably affect the performance of other functional coatings used with the article, such as an anti-reflective or anti-glare coating.

In view of these considerations, there is a need for ETC coatings that can be used with glass, glass-ceramic, and/or ceramic articles to facilitate the durability of the coating and methods for manufacturing an article having such a coating. There is further a need for such a coating when used with an article including an anti-reflective coating.

### SUMMARY

According to an embodiment of the present disclosure, an article includes a glass, glass-ceramic, or ceramic substrate having a primary surface and an anti-reflective coating disposed over the primary surface of the substrate. An intermediate coating containing a cured polysilazane or a silsesquioxane material can be disposed over the anti-reflective coating and an easy-to-clean (ETC) coating containing a fluorinated material can be disposed directly on the intermediate coating. The intermediate coating can have an elastic modulus of from about 9 GPa to about 40 GPa.

According to another embodiment of the present disclosure, an article includes a glass, glass-ceramic, or ceramic substrate having a primary surface and an anti-reflective coating disposed over the primary surface of the substrate. An intermediate coating containing a cured polysilazane or a silsesquioxane material can be disposed over the anti-reflective coating and a polymer coating can be disposed directly on the intermediate coating. The polymer coating can have a water contact angle of >105 degrees after being subjected to 200,000 reciprocating cycles under a 1 kg load according to a Cheesecloth Abrasion Test.

According to another embodiment, a method of manufacturing an article is provided. The method includes depositing an intermediate coating solution on an anti-reflective coating disposed on a primary surface of a glass, glass-ceramic, or ceramic substrate. The solution can include a polysilazane or a silsesquioxane material. The method also includes depositing a fluorinated material directly on the deposited solution. The polysilazane or the silsesquioxane material can be cured at a temperature of about 300 oC or less to form an intermediate coating, wherein the curing occurs one of prior to, at the same time as, or subsequent to the step of depositing a fluorinated material. The method also includes curing the fluorinated material to form an easy-to-clean (ETC) coating disposed directly on the intermediate coating.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a cross-sectional, schematic view of an article comprising a glass, glass-ceramic, or ceramic substrate with an anti-reflective coating, an intermediate coating, and an ETC coating, according to embodiments of the present disclosure;

FIG. 2A is a flow chart illustrating a method of forming a glass, glass-ceramic, or ceramic substrate with an anti-reflective coating, an intermediate coating, and an ETC coating, according to embodiments of the present disclosure;

FIG. 2B is a flow chart illustrating a method of forming a glass, glass-ceramic, or ceramic substrate with an anti-reflective coating, an intermediate coating, and an ETC coating, according to embodiments of the present disclosure;

FIG. 3 is a plot of Fourier Transform Infrared Spectroscopy (FTIR) spectra of articles including a glass substrate and exemplary intermediate coatings made from uncatalyzed perhydropolysilazane (PHPS) cured for 30 minutes at 180 oC, 275 oC, and 400 oC, according to embodiments of the present disclosure;

FIG. 4 is a plot of FTIR spectra of articles including a glass substrate and exemplary intermediate coatings made from catalyzed perhydropolysilazane (PHPS) cured for 30 minutes at 180 oC, 275 oC, and 400 oC, according to embodiments of the present disclosure;

FIG. 5 is a plot comparing an initial static water contact angle and a static water contact angle after 200,000 reciprocating cycles of a Cheesecloth Abrasion Test for articles including a glass substrate and an ETC coating deposited on exemplary intermediate coatings made from catalyzed and uncatalyzed perhydropolysilazane (PHPS) cured for 30 minutes at 150 oC, 180 oC, 275 oC, and 400 oC, according to embodiments of the present disclosure;

FIG. 6 is a plot of coating elastic modulus as a function of cure temperature for articles including a glass substrate and exemplary intermediate coatings made from catalyzed and uncatalyzed perhydropolysilazane (PHPS) cured for 30 minutes at 150 oC, 180 oC, 275 oC, and 400 oC, according to embodiments of the present disclosure;

FIG. 7 is a plot of water contact angle (WCA) after 200,000 reciprocating cycles of a Cheesecloth Abrasion Test on the articles of FIG. 5 including an ETC coating deposited on exemplary intermediate coatings made from catalyzed and uncatalyzed perhydropolysilazane (PHPS) cured at 150 oC, 180 oC, 275 oC, and 400 oC as a function of elastic modulus of the respective intermediate coatings of the articles of FIG. 6, according to embodiments of the present disclosure;

FIG. 8 is a plot of surface composition of the top 10 nm of the surface (in atomic percent), as measured by X-ray Photoelectron Spectroscopy (XPS), of articles having a glass substrate and including exemplary intermediate coatings as the top layer made from uncatalyzed PHPS cured at 150 oC for 30 minutes, uncatalyzed PHPS cured at 180 oC for 60 minutes, and catalyzed PHPS cured at 150 oC for 30 minutes, according to embodiments of the present disclosure;

FIG. 9 is a plot of surface concentration of fluorine in the top 10 nm of the surface (in atomic percent), as measured by X-ray Photoelectron Spectroscopy (XPS), of a comparative article including an anti-reflective coating deposited as the top layer on a glass substrate and several exemplary articles having a glass substrate and including an intermediate coating as the top layer made from uncatalyzed PHPS cured at 150 oC for 30 minutes, uncatalyzed PHPS cured at 180 oC for 30 minutes, catalyzed PHPS cured at 275 oC for 30 minutes, and catalyzed PHPS cured at 400 oC for 30 minutes, according to embodiments of the present disclosure;

FIG. 10 is a plot of FTIR spectra of articles including a glass substrate and uncatalyzed and catalyzed hydrogen silsesquioxane (HSQ) cured at 150 oC at low and high humidity, according to embodiments of the present disclosure;

FIG. 11 is a plot of water contact angle as a function of reciprocating cycles of a Steel Wool Test for articles including an anti-reflective coating deposited on a glass substrate and (a) an ETC coating deposited on the anti-reflective coating (control), (b) an ETC coating deposited on an HSQ coating deposited on the anti-reflective coating and cured at 400 oC, and (c) an ETC coating deposited on an exemplary intermediate coating including a cured PHPS coating deposited on the anti-reflective coating according to embodiments of the present disclosure; and

FIG. 12 is a plot comparing an initial water contact angle and a water contact angle after 200,000 reciprocating cycles of a Cheesecloth Abrasion Test for articles including an anti-reflective coating deposited on a glass substrate and an anti-reflective and (a) an ETC coating deposited on the anti-reflective coating (control), (b) an ETC coating deposited on an HSQ coating deposited on the anti-reflective coating and cured at 400 oC, (c) an ETC coating deposited on an exemplary intermediate coating including a catalyzed, cured HSQ coating deposited on the anti-reflective coating, and (d) an ETC coating deposited on an exemplary intermediate coating including a cured PHPS coating deposited on the anti-reflective coating according to embodiments of the present disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “formed from” can mean one or more of comprises, consists essentially of, or consists of For example, a component that is formed from a particular material can comprise the particular material, consist essentially of the particular material, or consist of the particular material.

As also used herein, the terms “article,” “glass-article,” “ceramic-article,” “glass-ceramics,” “glass elements,” “glass-ceramic article” and “glass-ceramic articles” may be used interchangeably, and in their broadest sense, to include any object made wholly or partly of glass and/or glass-ceramic material.

The elastic modulus (also referred to as Young's modulus) of the intermediate coating is provided in units of gigapascals (GPa). The elastic modulus values reported herein were measured using a KLA-Tencor G200 nanoindenter operating in the continuous stiffness mode (CSM) using a Berkovich diamond indenter, a CSM mode frequency of 52 Hz, an indentation strain rate of 0.05, and a maximum indentation depth of 350 nm (adjusted depending on the thickness of the coating being measured).

The Cheesecloth Abrasion Test data reported herein were determined as follows, unless otherwise stated. Five pieces of cheesecloth (50 mm×50 mm square, 200877, SDL Atlas Textile Innovators) were attached to a round head (20 mm diameter) of an abrader (5750, Taber Industries) using an O-ring. Weights totaling 410 g were added to the Taber spindle to result in a total applied load of 750 g. The stroke length was set at 15 mm and the speed was set to 30 cycles per minute. The area to be abraded was marked onto the back of the sample for tracking. Typically, each sample ran for 200,000 cycles, with the cheesecloth material changed every 50,000 cycles. Once the abrasion test was complete the sample was cleaned with a nitrogen gun and characterized using static water contact angles. For easy to clean (ETC) applications, the passing metric for static water contact angle is typically greater than 100 degrees after 200,000 cycles.

The Steel Wool Abrasion Test data reported herein was determined as follows, unless otherwise stated. Steel wool (Bonstar #0000) was first cut into strips (25 mm×12 mm) and placed on a sheet of aluminum foil to bake in an oven for 2 hours at 100° C. The steel wool strip was fitted to an attachment (10 mm×10 mm) of an abrader (5750, Taber Industries) using a zip tie. Weights totaling 720 g were added to the Taber arm to result in a total applied load of 1 kg. The stroke length was set at 25 mm and the speed was set to 40 cycles per minute. The area to be abraded was marked onto the back of the sample for tracking. Typically, each sample fit two tracks, one track was run for 2000 cycles and the second track was run for 3000 cycles. Once the abrasion test was complete the sample was characterized using static water contact angles. For easy to clean (ETC) applications, the passing metric for static water contact angle is typically greater than 100° after 3000 cycles.

The term “disposed” is used herein to refer to a layer or sub-layer that is coated, deposited, formed, or otherwise provided onto a surface. The term disposed can include layers/sub-layers provided in direct contact with adjacent layers/sub-layers or layers/sub-layers separated by intervening material which may or may not form a layer.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Embodiments of the present disclosure relate to articles and methods of manufacturing such an article that include a glass, glass-ceramic, or ceramic substrate having a primary surface, an anti-reflective coating disposed over the primary surface, an intermediate coating containing a cured polysilazane or a silsesquioxane material disposed over the anti-reflective coating, and an easy-to-clean (ETC) coating disposed directly on the intermediate coating. The intermediate coating can enhance the abrasion resistance of the ETC coating deposited over the intermediate coating. In some embodiments, the material forming the intermediate coating is deposited and cured at a low temperature, such as 300 oC or less. Curing at low temperatures, such as 300 oC or less, and in some cases 200 oC or less, may be less likely to affect the optical characteristics of the underlying anti-reflective coating compared to higher curing temperatures. The lower cure temperatures may also facilitate simplifying manufacturing processes by facilitating the use of lower temperatures and/or by providing opportunities to utilize a single curing to cure the intermediate coating and the ETC coating. In some embodiments, the material used to form the intermediate coating can include a catalyst that is adapted to catalyze the polysilazane or the silsesquioxane material to facilitate curing at lower temperatures.

The articles disclosed herein may be incorporated into a device article such as a device article with a display (or display device articles), non-limiting examples of which include consumer electronics (including mobile phones, tablets, computers, navigation systems, wearable devices, such as watches, and the like), architectural device articles, transportation device articles (e.g., automotive, trains, aircraft, sea craft, etc.), and appliance device articles.

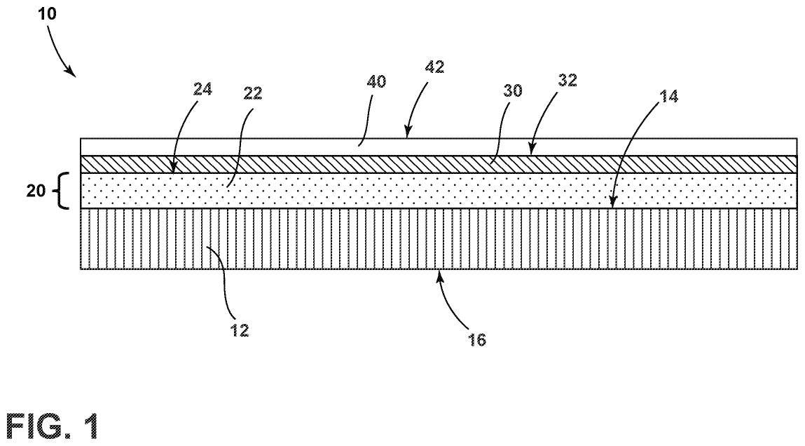

Referring to FIG. 1, an article 10 is illustrated according to an aspect of the present disclosure. The article 10 can include a substrate 12 that includes a glass, glass-ceramic, or ceramic composition. The article 10 can include a pair of opposing primary surfaces, first primary surface 14 and second primary surface 16. An optical film 20 is disposed on at least one of the first primary surface 14 and second primary surface 16. While the optical film 20 is illustrated as being disposed only on the first primary surface 14, aspects of the present disclosure include disposing the optical film 20 on the second primary surface 16 or both the first primary surface 14 and second primary surface 16. The optical film 20 includes at least one anti-reflective coating 22 defining an outer surface 24 of the optical film 20. An intermediate coating 30 containing a cured polysilazane or a cured silsesquioxane material can be disposed over the optical film 20. An easy-to-clean (ETC) coating 40 can be disposed directly on an outer surface 32 of the intermediate coating 30, with the intermediate coating 30 disposed between the ETC 40 and the outer surface 24 of the at least one anti-reflective coating 22 of the optical film 20. The ETC coating 40 includes an outer surface 42 that may define a coated surface of the article 10.

The optical film 20 includes the at least one anti-reflective coating 22 and in some embodiments may include multiple anti-reflective coatings forming an anti-reflective stack. Optionally, the optical film 20 can include one or more additional layers/sub-layers and/or coatings adapted to provide the article 10 with a desired optical property. Additional non-limiting examples of components of the optical film 20 include anti-glare coatings, scratch-resistant coatings, impedance matching layers, and combinations thereof. In some embodiments, the optical film 20 can include one or more additional layers/sub-layers and/or coatings disposed between the at least one anti-reflective coating 22 and the first primary surface 14 of the substrate 12.

The optical film 20 may include a multi-layer coating with each layer having a different refractive index. In some embodiments, the multi-layer coating comprises one or more low refractive index layers and one or more high refractive index layers, alternating in their sequencing over one another. For example, the optical film 20 may include a low refractive index material L having a refractive index from about 1.3 to about 1.6, a medium refractive index material M having a refractive index from about 1.6 to about 1.7, or a high refractive index material H having a refractive index from about 1.7 to about 3.0. As used herein, the term “index” and “refractive index” both refer to the index of refraction of the material. Examples of suitable low refractive index materials include silica, fused silica, fluorine-doped fused silica, MgF2, CaF2, YF and YbF3. Examples of suitable medium refractive index material include Al2O3. Examples of suitable high refractive index materials include ZrO2, HfO2, Ta2O5, Nb2O5, TiO2, Y2O3, Si3N4, SrTiO3, and WO3. In some embodiments, the source materials for the optical film 20 may also include transparent oxide coating (TCO) materials. Examples of suitable TCO materials may also include, but are not limited to, indium tin oxide (ITO), aluminum doped zinc oxide (AZO), zinc stabilized indium tin oxide (IZO), In2O3, and other binary, ternary, or quarternary oxide compounds suitable for forming a doped metal oxide coating.

The source materials of the optical film 20 may be deposited as a single layer coating or a multilayer coating. In some embodiments, a single layer coating is formed using a low refractive index material L as the optical coating source material. In other embodiments, a single layer coating is formed using a MgF2 optical coating source material. The single layer coating may have a selected thickness. In some embodiments, the thickness of the single layer coating may be greater than or equal to 50 nm, 60 nm, or 70 nm. In some embodiments, the thickness of the single layer coating may be less than or equal to 2,000 nm, 1,500 nm, 1,000 nm, 500 nm, 250 nm, 150 nm, or 100 nm.

The source materials for the optical film 20 may also be deposited as a multilayer coating. In some embodiments, the multilayer coating may comprise alternating layers of a low refractive index material L, a medium refractive index material M, and a high refractive index material H. In other embodiments, the multilayer coating may comprise alternating layers of a high refractive index material H and one of (i) a low refractive index material L or (ii) a medium refractive index material M. The layers may be deposited such that the order of the layers is H(L or M) or (L or M)H. Each pair of layers, H(L or M) or (L or M)H, may form a coating period or period. The optical film 20 may comprise at least one coating period to provide the desired optical properties, including, for example and without limitation, anti-reflective properties. In some embodiments, the optical film 20 comprises a plurality of coating periods, wherein each coating period containing one high refractive index material and one of a low or medium refractive index material. The number of coating periods present in a multilayer coating may be from 1 to 1000. In some embodiments, the number of coating periods present in a multilayer coating may be from 1 to 500, from 2 to 500, from 2 to 200, from 2 to 100, or from 2 to 20.

In some embodiments, the source materials of the optical film 20 may be selected such that the same refractive index materials are used in each coating period or the optical film source materials may be selected such that different refractive index materials are used in each coating period. For example, in an optical film 20 having two coating periods, the first coating period may comprise SiO2 only and the second period may comprise TiO2/SiO2. The ability to vary the alternating layers and coating period may allow a complicated optical filter having the desired optical properties, and including an anti-reflective coating, to be formed.

The thickness of each layer in a coating period of the optical film 20, i.e., the H layer and the L (or M) layer, may independently be from about 5 nm to about 200 nm, from about 5 nm to about 150 nm, or from about 25 nm to about 100 nm. The multilayer coating may have a thickness of from about 100 nm to about 2000 nm, from about 150 nm to about 1500 nm, from about 200 nm to about 1250 nm, or from about 400 nm to about 1200 nm.

The components of the optical film 20 can be deposited using a variety of methods based on the particular component, non-limiting examples of which include physical vapor deposition (“PVD”), electron beam deposition (“e-beam” or “EB”), ion-assisted deposition-EB (“IAD-EB”), laser ablation, vacuum arc deposition, chemical vapor deposition (CVD), sputtering, plasma enhanced chemical vapor deposition (PECVD), and other similar deposition techniques.

In some embodiments, the substrate 12 includes a glass composition. The substrate 12, for example, can include a borosilicate glass, an aluminosilicate glass, soda-lime glass, chemically strengthened borosilicate glass, chemically strengthened aluminosilicate glass, and chemically strengthened soda-lime glass. The substrate may have a selected length and width, or diameter, to define its surface area. The substrate may have at least one edge between the first primary surface 14 and second primary surface 16 of the substrate 12 defined by its length and width, or diameter. In some embodiments, the substrate 12 has a thickness of from about 0.2 mm to about 1.5 mm, from about 0.2 mm to about 1.3 mm, and from about 0.2 mm to about 1.0 mm, or any ranges therebetween.

In some embodiments, the substrate 12 includes a glass-ceramic material having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite. “Glass-ceramics” include materials produced through controlled crystallization of glass. Examples of suitable glass-ceramics may include Li2O—Al2O3—SiO2 system (i.e., LAS-System) glass-ceramics, MgO—Al2O3—SiO2 system (i.e., MAS-System) glass-ceramics, ZnO×Al2O3×nSiO2 (i.e., ZAS system), and/or glass-ceramics that include a predominant crystal phase including β-quartz solid solution, β-spodumene, cordierite, and lithium disilicate. The glass-ceramic substrates may be strengthened using a chemical strengthening process.

In some embodiments, the substrate 12 includes a ceramic material such as inorganic crystalline oxides, nitrides, carbides, oxy nitrides, carbo nitrides, and/or the like. Illustrative ceramics include those materials having an alumina, aluminum titanate, mullite, cordierite, zircon, spinel, perovskite, zirconia, ceria, silicon carbide, silicon nitride, silicon aluminum oxynitride, or zeolite phase.

According to an embodiment of the present disclosure, the intermediate coating 30 includes a cured polysilazane or a silsesquioxane material. In some embodiments, the intermediate coating 30 is formed from a solution containing a polysilazane or a silsesquioxane material that is spin-coated onto the desired substrate and subsequently cured. In some embodiments, the polysilazane used to form the intermediate coating 30 is represented by the formula [-SiR2-NH-]n, where R is H or an alkyl group. The term “alkyl” is used herein to refer to a straight or branched aliphatic hydrocarbon group, non-limiting examples of which include methyl, ethyl, n-propyl, 2-propyl, n-butyl, sec-butyl, t-butyl, and hexyl groups. When R is a hydrogen, the polysilazane can be referred to as a perhydropolysilazane (PHPS). When R is an organic moiety, the polysilazane can be referred to as an organic polysilazane. The silsesquioxane material is represented by the formula [RSiO3/2]n, where R is H or an organic moiety such as an alkyl, aryl, or alkoxyl group. In some embodiments, the silsesquioxane material is a polyhedral oligomeric silsesquioxane material (also referred to as POSS). In some examples, the silsesquioxane material can have a cage-like or polymeric structure having Si—O—Si linkages and tetrahedral Si vertices. In some examples, the silsesquioxanes may form 6, 8, 10, or 12 silicon vertices in which each silicon center is bonded to three oxo groups, which in turn connect to other silicon centers. An exemplary silsesquioxane material is hydrogen silsesquioxane (HSQ) in which R is a hydrogen.

The intermediate coating 30 can have any desired thickness based on the intended application and/or components of the article, such as the type of anti-reflective coating 22 and/or ETC coating 40. The intermediate coating 30 can be disposed on flat or textured surfaces. In some embodiments, the intermediate coating 30 has a thickness of at least about 10 nm and in some applications may be up to several micrometers (μm) in thickness. For example, the intermediate coating 30 can have a thickness of at least 10 nm, at least 15 nm, at least 50 nm, at least 100 nm, at least 500 nm, at least 1 μm, or at least 2 μm.

According to an embodiment of the present disclosure, the intermediate coating 30 can be characterized by an elastic modulus of from about 9 GPa to about 40 GPa. For example, the intermediate coating 30 can be characterized by an elastic modulus of from about 9 GPa to about 40 GPa, about 10 GPa to about 40 GPa, about 15 GPa to about 40 GPa, about 20 GPa to about 40 GPa, about 30 GPa to about 40 GPa, about 35 GPa to about 40 GPa, about 9 GPa to about 35 GPa, about 10 GPa to about 35 GPa, about 15 GPa to about 35 GPa, about 20 GPa to about 35 GPa, about 30 GPa to about 35 GPa, about 9 GPa to about 30 GPa, about 10 GPa to about 30 GPa, about 15 GPa to about 30 GPa, about 20 GPa to about 30 GPa, about 9 GPa to about 25 GPa, about 10 GPa to about 25 GPa, about 15 GPa to about 25 GPa, about 20 GPa to about 25 GPa, about 9 GPa to about 20 GPa, about 10 GPa to about 20 GPa, about 15 GPa to about 20 GPa, or about 10 GPa to about 15 GPa. In some examples, the intermediate coating 30 can be characterized by an elastic modulus of about 9 GPa, about 10 GPa, about 15 GPa, about 16 GPa, about 17 GPa, about 18 GPa, about 20 GPa, about 30 GPa, about 32 GPa, 33 GPa, about 34 GPa, about 35 GPa, about 39 GPa, about 40 GPa, or any elastic modulus value between these values.

In some embodiments, the polysilazane or silsesquioxane material used to form the intermediate coating 30 can be cured at a time and temperature sufficient to provide a cured polysilazane or a cured silsesquioxane material having the desired elastic modulus. Without wishing to be bound by any particular theory, it has been found that curing the polysilazane or silsesquioxane to provide a cured intermediate coating 30 having an elastic modulus within a range of from about 9 GPa to about 40 GPa facilitates improving the durability of an ETC coating deposited on the intermediate coating 30 compared to intermediate coatings 30 having an elastic modulus outside this range and compared to articles that do not include an intermediate coating 30.

The easy-to-clean (ETC) coating 40 can be disposed directly on the outer surface 32 of the intermediate coating 30. In some embodiments, the ETC coating 40 can include any suitable polymer material and/or fluorinated material, examples of which include a fluorinated material with silane moieties, a fluoroether silane, a perfluoropolyether (PFPE) silane, a perfluoroalkylether, and a PFPE oil. According to one aspect, a thickness of the ETC coating 40 is from about 1 nm to about 20 nm. In other aspects, the thickness of the ETC coating 40 is from about 1 nm to about 20 nm, about 2 nm to about 10 nm, about 3 nm to about 10 nm, about 4 nm to about 10 nm, about 5 nm to about 10 nm, about 1 nm to about 200 nm, about 1 nm to about 100 nm, about 1 nm to about 50 nm, about 2 nm to about 200 nm, about 2 nm to about 100 nm, about 2 nm to about 50 nm, about 5 nm to about 200 nm, about 5 nm to about 100 nm, about 5 nm to about 50 nm, about 1 nm to about 2 nm, about 1 nm to about 3 nm, about 1 nm to about 4 nm, about 1 nm to about 5 nm, about 2 nm to about 3 nm, about 2 nm to about 4 nm, or about 2 nm to about 5 nm. For example, the ETC coating 40 can have a thickness of about 1 nm, about 2 nm, about 3 nm, about 4 nm, about 5 nm, about 10 nm, about 15 nm, about 20 nm, about 50 nm, about 100 nm, about 200 nm, or any thickness between these values. In some examples, the ETC coating 40 may be a monolayer either vertically or horizontally arranged on the outer surface 30 of the anti-reflective coating 22.

According to some embodiments, the ETC coating 40 can be characterized by a durability as determined by a Steel Wool Abrasion Test. As used herein, the “Steel Wool Abrasion Test” is a test employed to determine the durability of the ETC coating 40 on the optical film 20 according to an aspect of the present disclosure. At the beginning of a Steel Wool Abrasion Test, an initial water contact angle is measured A steel wool pad is then allowed to make contact with the sample on the coated surface thereof under predetermined conditions. The average contact angle is then measured on the sample after a predetermined number of cycles, e.g., 2000 cycles, 3000 cycles, etc. Without being bound by theory, a smaller change in the average contact angle over time is indicative of an increase in durability of the measured coating. The Steel Wool Abrasion Test data reported herein was obtained according to the conditions specified above.

According to an aspect of the present disclosure, the ETC coating 40 exhibits an average contact angle with water of at least about 100 degrees, at least about 105 degrees, or at least about 110 degrees after being subjected to 2000 reciprocating cycles under a load of 1 kg according to a Steel Wool Abrasion Test. In some aspects, the ETC coating 40 exhibits an average contact angle with water of at least about 100 degrees, at least about 105 degrees, or at least about 110 degrees after being subjected to 3000 reciprocating cycles under a load of 1 kg according to a Steel Wool Abrasion Test. In some examples, the ETC coating 40 can exhibit an average contact angle with water of about 100 degrees or greater, about 102 degrees or greater, about 105 degrees or greater, about 106 degrees or greater, about 107 degrees or greater, about 108 degrees or greater, about 110 degrees or greater, or about 112 degrees or greater after being subjected to 2000 reciprocating cycles under a load of 1 kg according to a Steel Wool Abrasion Test. In some aspects, the ETC coating 40 can exhibit an average contact angle with water of about 100 degrees to about 120 degrees, about 102 degrees to about 120 degrees, about 105 degrees to about 120 degrees, about 107 degrees to about 120 degrees, about 110 degrees to about 120 degrees, about 112 degrees to about 120 degrees, about 100 degrees to about 115 degrees, about 102 degrees to about 115 degrees, about 105 degrees to about 115 degrees, about 107 degrees to about 115 degrees, about 110 degrees to about 115 degrees, or about 112 degrees to about 115 degrees, after being subjected to 2000 reciprocating cycles under a load of 1 kg according to a Steel Wool Abrasion Test. In some aspects, the ETC coating 40 exhibits an average contact angle with water of about 100 degrees to about 120 degrees, about 102 degrees to about 120 degrees, about 105 degrees to about 120 degrees, about 107 degrees to about 120 degrees, about 110 degrees to about 120 degrees, about 112 degrees to about 120 degrees, about 100 degrees to about 115 degrees, about 102 degrees to about 115 degrees, about 105 degrees to about 115 degrees, about 107 degrees to about 115 degrees, about 110 degrees to about 115 degrees, about 112 degrees to about 115 degrees, or about 105 degrees to about 110 degrees, after being subjected to 3000 reciprocating cycles under a load of 1 kg according to a Steel Wool Abrasion Test.

According to some embodiments, the ETC coating 40 can be characterized by a durability as determined by a Cheesecloth Abrasion Test. As used herein, the “Cheesecloth Abrasion Test” is a test employed to determine the durability of the ETC coating 40 on the optical film 20 according to an aspect of the present disclosure. At the beginning of a Cheesecloth Abrasion Test, a water contact angle is measured on the particular sample one or more times to obtain a reliable initial water contact angle. The cheesecloth is then allowed to make contact with the sample on the coated surface thereof under specified conditions. The average contact angle is then measured on the sample after a predetermined number of cycles, such as 200,000 cycles. Without being bound by theory, a smaller change in the average contact angle over time is indicative of an increase in durability of the measured coating. The Cheesecloth Abrasion Test data reported herein was obtained according to the conditions specified above.

According to an embodiment of the present disclosure, the ETC coating 40 can exhibit an average contact angle with water of at least about 105 degrees, at least about 110 degrees, or at least about 115 degrees after being subjected to 200,000 reciprocating cycles according to a Cheesecloth Abrasion Test. For example, the ETC coating 40 can exhibit an average contact angle with water of from about 105 degrees to about 125 degrees, about 105 degrees to about 120 degrees, about 105 degrees to about 115 degrees, about 105 degrees to about 110 degrees, about 110 degrees to about 125 degrees, about 110 degrees to about 120 degrees, about 110 degrees to about 115 degrees, about 112 degrees to about 125 degrees, about 112 degrees to about 120 degrees, about 112 degrees to about 115 degrees, about 115 degrees to about 125 degrees, or about 115 degrees to about 120 degrees after being subjected to 200,000 reciprocating cycles according to a Cheesecloth Abrasion Test.

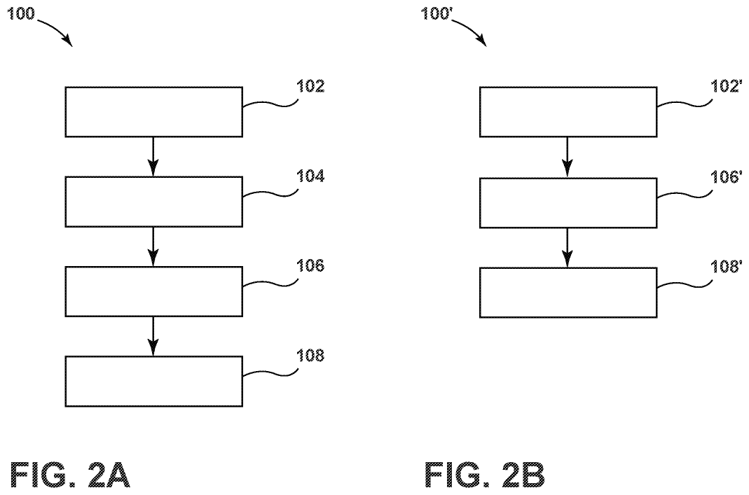

Referring now to FIGS. 2A and 2B, a method 100 and method 100′, respectively, for forming an article according to an aspect of the present disclosure is illustrated. The methods 100, 100′ are similar except that the method 100 includes first and second curing steps 104 and 108, whereas the method 100′ includes a single curing step 108′. The methods 100, 100′ can be used to form an article, such as the article 10 described above with respect to FIG. 1, which includes the intermediate coating 30 according to the present disclosure. The methods 100, 100′ can be used with any article to facilitate forming the ETC coating 40 with improved abrasion resistance by providing a coating that contains a cured polysilazane or silsesquioxane material upon which the ETC coating 40 can be directly deposited.

With regard FIG. 2A, the method 100 can include a step 102 of depositing a solution containing a polysilazane or a silsesquioxane material onto a substrate. With respect to the exemplary embodiment of FIG. 1, the solution can be deposited on the anti-reflective coating 22 of the optical film 20 of the article 10. As described above with respect to the substrate 12 of the article 10, the substrate 12 can be a glass, glass-ceramic, or ceramic material. The anti-reflective coating 22, and any other optional components of the optical film 20 described herein, can be provided on the substrate 12 according to any conventional method for depositing such materials, examples of which include physical vapor deposition (“PVD”), electron beam deposition (“e-beam” or “EB”), ion-assisted deposition-EB (“IAD-EB”), laser ablation, vacuum arc deposition, sputtering, plasma enhanced chemical vapor deposition (PECVD).

The solution containing a polysilazane or a silsesquioxane can be deposited in any suitable manner to provide a layer of material having a desired thickness. In an exemplary embodiment, the solution is spin-coated onto the anti-reflective coating 22. The amount of solution, spin-coat speed, and spin time can be selected to provide a layer of material having the desired thickness.

In some embodiments, the solution containing a polysilazane or a silsesquioxane material can also include a catalyst adapted to catalyze the polysilazane or silsesquioxane material during curing. The catalyst can facilitate curing the material to a desired degree at a lower temperature than would typically be obtained in the absence of the catalyst. Non-limiting examples of suitable catalysts include hexylamine, aminopropyl trialkoxysilane, alkylamines, acetone oxime, and cyclohexylamine. In some embodiments, the catalyst is a suitable primary, secondary, or tertiary amine base. Without wishing to be limited by any theory, it is believed that unhindered primary amine bases may react faster than secondary or tertiary amine bases. In some embodiments, the catalyst can be a protected or non-protected primary amine. Hexylamine is an example of a suitable non-protected amine. Acetone oxime is an example of a protected amine. A 1% by volume (% v/v) solution of acetone oxime in pentyl propionate is one example of a catalyst solution. In some embodiments, the catalyst can be a protected amine that is activated in the presence of an activator molecule or activated by exposure to UV or thermal energy.

The method 100 can include a first curing step 104, prior to the step 106, to cure the polysilazane or silsesquioxane in the solution deposited in step 102 to form the intermediate coating 30 prior to step 106. The curing step 104 can include heating the deposited polysilazane or polyhedral oligomeric silsesquioxane at a temperature of about 300 oC or less. In some examples, the curing step 104 can include heating at a temperature of about 300 oC or less, about 275 oC or less, about 250 oC or less, about 225 oC or less, about 200 oC or less, about 180 oC or less, or about 150 oC or less. For example, the curing step 104 can include heating at a temperature of from about 125 oC to about 300 oC, about 150 oC to about 300 oC, about 180 oC to about 300 oC, about 200 oC to about 300 oC, about 225 oC to about 300 oC, about 250 oC to about 300 oC, about 125 oC to about 275 oC, about 150 oC to about 275 oC, about 180 oC to about 275 oC, about 200 oC to about 275 oC, about 225 oC to about 275 oC, about 275 oC to about 300 oC, about 125 oC to about 250 oC, about 150 oC to about 250 oC, about 180 oC to about 250 oC, about 200 oC to about 250 oC, about 225 oC to about 250 oC, about 125 oC to about 225 oC, about 150 oC to about 225 oC, about 180 oC to about 225 oC, about 200 oC to about 225 oC, about 125 oC to about 200 oC, about 150 oC to about 200 oC, about 180 oC to about 200 oC, about 125 oC to about 180 oC, or about 150 oC to about 180 oC. In some examples, the curing step 104 can include heating at a temperature of about 125 oC, about 150 oC, about 175 oC, about 180 oC, about 200 oC, about 225 oC, about 250 oC, about 275 oC, about 300 oC, or any temperature between these values. The curing step 104 can be conducted for any suitable length of time, non-limiting examples of which include about 15 minutes, about 30 minutes, about 60 minutes, about 120 minutes, or any period of time between these values.

In some embodiments, the time and temperature of the curing step 104 can be based on a variety of factors, examples of which include, the type of polysilazane or silsesquioxane in the solution, the presence or absence of a catalyst, the type of catalyst, a thickness of the coating, and the desired degree of curing. As discussed herein, in some embodiments the polysilazane or silsesquioxane are cured to a predetermined degree to provide an intermediate coating 30 having a desired elastic modulus, which can facilitate improving the abrasion resistance of a subsequently applied ETC coating 40.

In some embodiments, the curing step 104 can include heating the deposited polysilazane or silsesquioxane, and the optional catalyst, at a predetermined temperature of about 300 oC or less for a predetermined period of time to provide a cured intermediate coating 30 having a desired elastic modulus in the range of from about 9 GPa to about 40 GPa, as discussed above.

At step 106, a polymeric and/or fluorinated material suitable for forming the ETC coating 40 can be deposited directly onto the intermediate coating 30 containing the polysilazane or silsesquioxane formed in the first curing step 104. The polymeric and/or fluorinated material can be any of the materials described above for forming the ETC coating 40. The polymeric and/or fluorinated material can be deposited in any suitable manner, examples of which include spin-coating, spraying, etc.

Subsequent to the deposition of the polymeric and/or fluorinated material at step 106, the article can be heated at step 108 to cure the polymeric and/or fluorinated material to form the ETC coating 40. The curing step 108 can include heating the article at a time and temperature suitable for curing the deposited polymeric and/or fluorinated material to form the ETC coating 40. For example, a perfluoropolyether (PFPE) solution can be spray coated onto the intermediate coating 30 and cured at about 150 oC to form the ETC coating 40.

Referring now to FIG. 2B, the method 100′ is similar to the method 100 of FIG. 2A except that the method 100′ forms the intermediate coating 40 and the ETC coating 40 in a single curing step 108′ rather than the separate curing steps 104 and 108 of the method 100. The step 102′ of depositing the solution containing a polysilazane or a silsesquioxane material onto a substrate can proceed in a manner similar to that described above for step 102 of the method 100 of FIG. 2A.

Following the step 102′, a polymeric and/or fluorinated material can be deposited at step 106′ onto the solution deposited in step 102′. Because there is no curing step between the step 102′ and 106′, the polymeric and/or fluorinated material is deposited onto an uncured solution containing the polysilazane or silsesquioxane material. The material deposited in step 106′ may be any of the materials discussed above with respect to the step 106 of method 100. In some embodiments, the steps 102′ and 106′ can occur sequentially and may proceed through different deposition processes. In other embodiments, the depositing steps 102′ and 106′ can occur simultaneously, such as by spin coating or spray coating.

At step 108′ the materials deposited in steps 102′ and 106′ can be heated to cure both the polysilazane or silsesquioxane material and the polymeric and/or fluorinated material to form the intermediate coating 30 and the ETC coating 40 in a single curing step. In some embodiments, to facilitate curing both the polysilazane or silsesquioxane material and the polymeric and/or fluorinated material in a single step, the solution deposited in step 102′ can include a catalyst configured to catalyze curing the polysilazane or silsesquioxane material, as described above with respect to the step 102 of method 100. The catalyst can be adapted to facilitate curing the polysilazane or silsesquioxane material to a desired degree at a lower temperature compared to curing in the absence of the catalyst. Many conventional materials for forming ETC coatings are cured at temperatures less than 200 oC (e.g., PFPE is typically cured at about 150 oC). Thus, the addition of a suitable catalyst to the polysilazane or silsesquioxane material deposited in step 102′ to lower the curing temperature can facilitate forming both the intermediate coating 30 having the desired degree of curing and the ETC coating 40 in a single curing step 108′.

The curing temperature and time in step 108′ can be selected based at least in part on the polysilazane or silsesquioxane material deposited in step 102′, the optional catalyst, and the polymeric and/or fluorinated material deposited in step 102′. For example, the polysilazane or silsesquioxane material and optional catalyst can be selected in concert with the curing conditions of step 108′ to provide an intermediate coating 30 having an elastic modulus of from about 9 GPa to about 40 GPa and to cure the material forming the ETC coating 40.

The embodiments of the present disclosure provide materials and methods for improving the abrasion resistance of an ETC coating 40 and in some embodiments for facilitating the process for manufacturing articles including such coatings. The embodiments of the present disclosure can facilitate improving the abrasion resistance of an ETC coating 40 deposited on a substrate which already includes an anti-reflective coating 22 and/or other optical coatings and layers. The materials and methods described herein can provide the improved abrasion resistance upon curing of a polysilazane or silsesquioxane material at temperatures of about 300 oC or less and in some embodiments upon curing at temperatures of about 200 oC or less. Curing at temperatures above 300 oC may undesirably affect the optical characteristics of other coatings/layers that may already be present as part of the article prior to the deposition of the ETC coating 40, particularly the optical characteristics of many conventional anti-reflective coatings. The present disclosure provides materials that can be cured to form an intermediate coating that improves the abrasion resistance of a subsequently deposited ETC coating 40, even when cured at low temperatures.

HSQ is an example of a silsesquioxane that can be used to form an intermediate coating 30 to improve the abrasion resistance of a subsequently deposited ETC coating 40. However, in order to see the greatest improvement in abrasion resistance, the HSQ coating is cured at about 400 oC prior to forming the ETC coating 40. The optical characteristics of many conventional anti-reflective coatings may be affected by curing at this high temperature, which can limit the ability to use this process for improving abrasion resistance with articles that include an anti-reflective coating. In some embodiments of the present disclosure, HSQ and other polyhedral oligomeric silsesquioxane (POSS) materials can be combined with an appropriate catalyst to facilitate curing the POSS material at temperatures of 300 oC or less, while also providing a similar or improve effect on the abrasion resistance of the ETC coating 40 compared to the high temperature cured HSQ.

In some embodiments, a low temperature (≤300 oC) cured intermediate coating 30 is provided by a polysilazane material. Polysilazanes can include groups that can be hydrolyzed in the presence of moisture, typically at low temperatures. For example, perhydropolysilazane (PHPS) includes repeating units of [—SiH2—NH—SiH2—] that can react with atmospheric moisture, resulting in the hydrolysis of the Si—H and Si—NH bonds to Si—O to form silica. This hydrolysis reaction occurs slowly at room temperature, but can be accelerated with increasing temperatures. The addition of a suitable catalyst can also lower the curing temperature. The embodiments of the present disclosure include uncatalyzed and catalyzed polysilazane materials that can be cured at temperatures of about 300 oC or less and still provide an improvement in the abrasion resistance of a subsequently applied ETC coating 40.

In addition, the present polysilazane or a polyhedral oligomeric silsesquioxane materials and optional catalysts can be applied using a spin coating process, which can be advantageous in some manufacturing processes (e.g., compared to more complex deposition processes, such as vacuum deposition processes).

Without wishing to be limited by any particular theory, it is believed that the present polysilazane or silsesquioxane materials and optional catalysts, when cured, can provide a network of Si—O bonds (referred to as SiOx) that are capable of reacting with materials used to form the ETC coating 40. The SiOx network may provide an increase in capacity for covalent bonding of the material used to form the ETC coating 40 (e.g., perfluoroether silane materials), which may facilitate more efficient usage of these materials. In addition, the present polysilazane or silsesquioxane materials have reactive groups that are heat activated, and thus the present materials may be less susceptible to hydrolytic degradation. Further, it is believed that the amount of active ETC material (e.g., silanes) bound to the intermediate coating is not entirely reliant on the number of active groups at the surface.

### EXAMPLES

The following examples describe various features and advantages provided by the disclosure, and are in no way intended to limit the invention and appended claims.

Table 1 below illustrates examples of intermediate coatings made using a perhydropolysilazane (PHPS) material according to the present disclosure. Examples 1A, 1B, 1C, and 1D (“Ex. 1A,” “Ex. 1B,” “Ex. 1C,” and “Ex. 1D”) included perhydropolysilazane (PHPS) deposited on an anti-reflective coating supported on a glass substrate and cured at the indicated times and temperatures in the absence of a catalyst (uncatalyzed). Examples 2A, 2B, 2C, and 2D (“Ex. 2A,” “Ex. 2B,” “Ex. 2C,” and “Ex. 2D”) included perhydropolysilazane (PHPS) deposited on an anti-reflective coating supported on a glass substrate and cured at the indicated times and temperatures in the presence of a catalyst (catalyzed). Ex. 1A-D and Ex. 2A-D were all prepared by spin coating a PHPS solution (with or without catalyst) onto a plasma treated anti-reflective coating on a glass substrate. A solution of PHPS in di-n-butyl ether was spin-coated at 1000 rpm for 30 seconds and then cured at the indicated times and temperatures. The uncatalyzed PHPS of Ex. 1A-D was Durazane 2250 and the catalyzed PHPS of Ex. 2A-D was Durazane 2850, both available from EMD Performance Materials. After curing, an ETC coating was formed on the samples. Each sample was plasma treated, followed by spray coating of a 0.6% by volume (%v/v) solution of a modified perfluoropolyether (PFPE) silane. The modified PFPE silane was Optool UD509, available from Daikin America, Inc. and was dissolved in Novec™ HFE 7200 engineered fluid, available from 3M™. The samples were then cured at 150 oC to form the ETC coating.

TABLE 1
Example Uncatalyzed and Catalyzed PHPS Intermediate Coatings

| | | Cure Temperature | Cure Time |
|---|---|---|---|
| Example | Catalyst | (° C.) | (min.) |
| Ex. 1A | None | 150 | 30 |
| Ex. 1B | None | 180 | 60 |
| Ex. 1C | None | 275 | 30 |
| Ex. 1D | None | 400 | 30 |
| Ex. 2A | Yes | 150 | 30 |
| Ex. 2B | Yes | 180 | 30 |
| Ex. 2C | Yes | 275 | 30 |
| Ex. 2D | Yes | 400 | 30 |

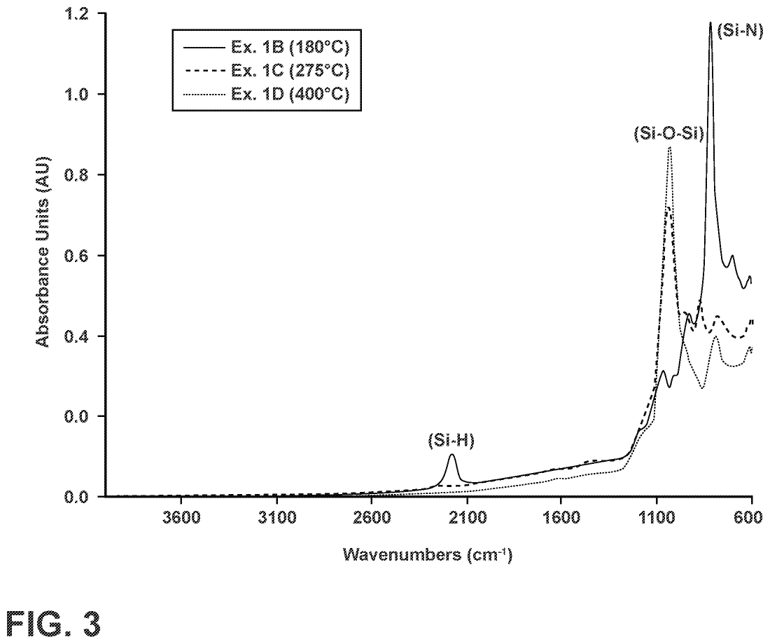

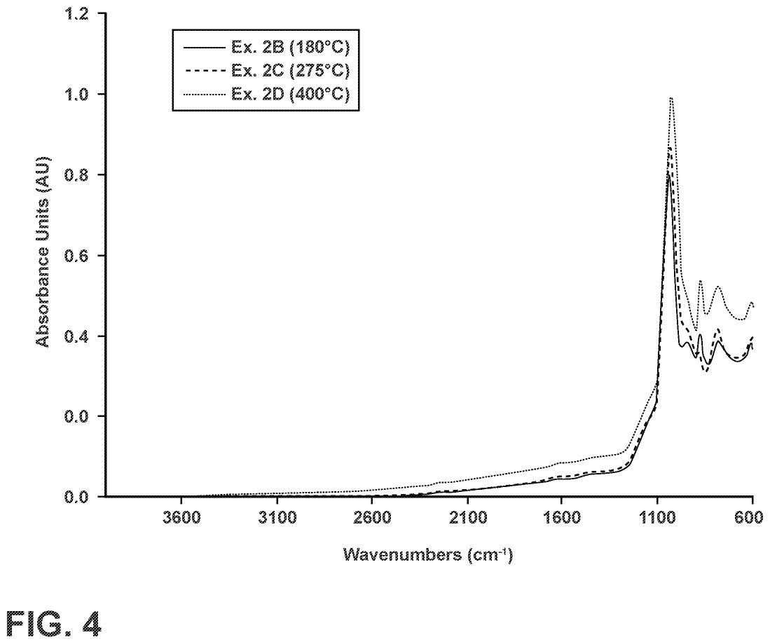

FIGS. 3 and 4 illustrate FTIR spectra of the cured PHPS coatings (prior to depositing the ETC coating) for the uncatalyzed Ex. 1B-D and the catalyzed Ex. 2B-D, respectively. The intensity of the Si—H and Si—N peaks in the FTIR spectra can be used as an indication of the extent of curing of the PHPS material. With regard to the uncatalyzed Ex. 1B-D samples shown in FIG. 3, heating at 180 oC (Ex. 1B) results in only partial curing of the PHPS material, as indicated by the presence of the Si—H and Si—N peaks in the spectrum. Ex. 1C and Ex. 1D suggest that as the curing temperature increases to 275 oC and 400 oC, respectively, the Si—H and Si—N peaks in the spectra become progressively less intense, suggesting a higher degree of curing as the temperature increases. As shown in FIG. 3, even when cured at 400 oC, the spectrum for Ex. 1D still shows the Si—N peak, suggesting that even when heated at 400 oC, the uncatalyzed PHPS is still not completely cured.

In contrast, as can be seen in FIG. 4, even at the lower curing temperature of 180 oC, the FTIR spectrum for the catalyzed Ex. 2B does not include the Si—H peak and exhibits a much lower intensity Si—N peak compared to the uncatalyzed Ex. 1B-D. The spectra in FIGS. 3 and 4 suggest that curing temperature and the presence of a catalyst can be used to control the degree of curing of the PHPS material. The spectra also illustrate that the addition of a catalyst to the PHPS material can reduce the temperature required to achieve a particular degree of curing of the PHPS material in a given time period.

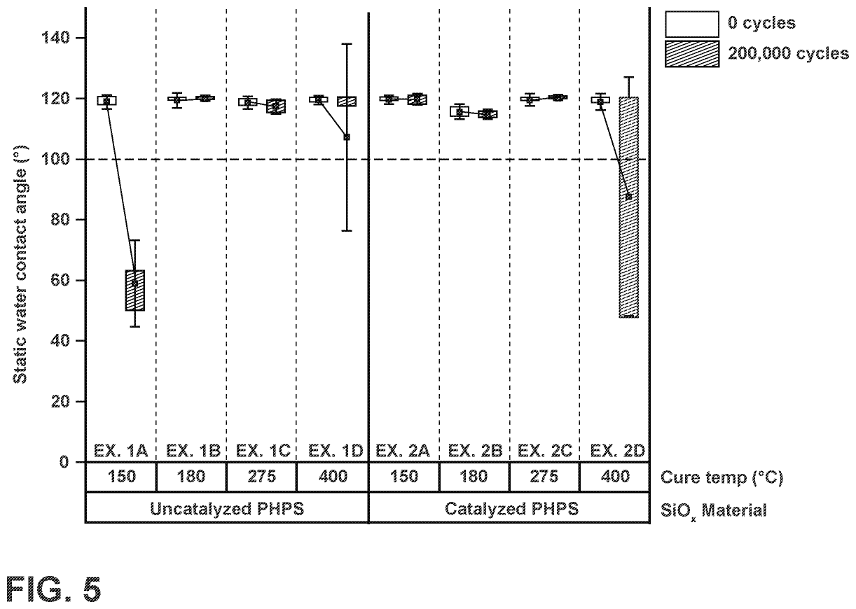

FIG. 5 illustrates the results of the Cheesecloth Abrasion Test for Ex. 1A-D and Ex. 2A-D. The water contact angle was measured on the cured ETC coating for each example prior to and after 200,000 reciprocating cycles. The water contact angle for the control sample (an ETC coating deposited as described above directly on the anti-reflective coating) after 200,000 cycles was about 100-105 oC, and is generally indicated in the graph by the dashed horizontal line at 100 degrees. As shown in FIG. 5, Ex. 1A (uncatalyzed, cured at 150 oC) did not exhibit any improvement in abrasion performance of the ETC coating compared to the control. However, the catalyzed example cured at 150 oC, Ex. 2A, does exhibit an improvement in abrasion performance of the ETC coating compared to the control. Uncatalyzed examples Ex. 1B and 2C and catalyzed examples Ex. 2B and 2C, cured at 180 oC and 275 oC, respectively, all show an improvement in the abrasion performance of the ETC coating compared to the control. The results for both the uncatalyzed example Ex. 1D and catalyzed Ex. 2D cured at 400 oC does not show an improvement in abrasion performance. The data for Ex. 1D and Ex. 2D suggest that there may be an upper limit on the effect of the degree of curing on the ETC abrasion performance. For example, the data in FIG. 5 suggests that there may be a minimum degree of curing required to improve the ETC abrasion performance and further that completely curing the PHPS material may not improve ETC abrasion performance and may in some cases negatively affect the abrasion performance.

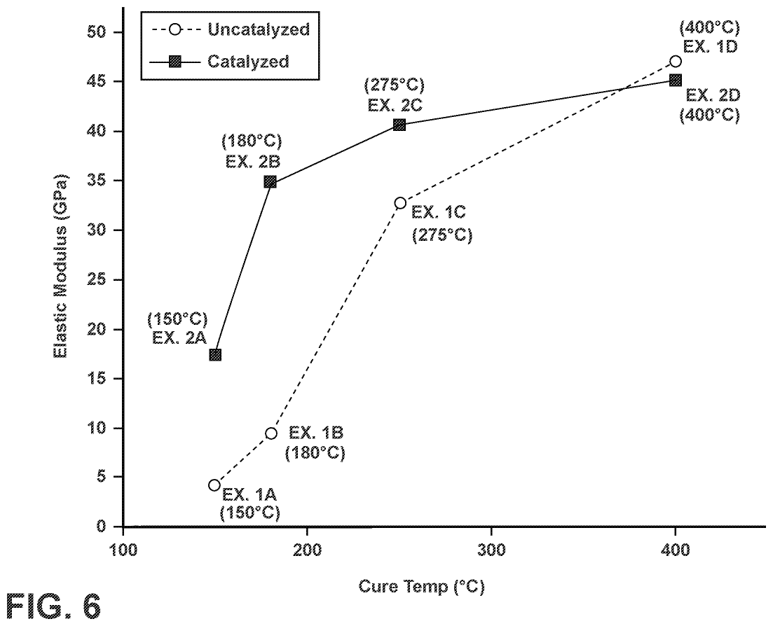

FIG. 6 shows the elastic modulus of the cured uncatalyzed and catalyzed PHPS coatings of Ex. 1A-D and Ex. 2A-D, prior to forming the ETC coating. Ex. 1A-D and Ex. 2A-D both show an increase in elastic modulus of the PHPS coating with increasing cure temperature. At lower cure temperatures, the catalyzed PHPS coating exhibits a much higher elastic modulus compared to the uncatalyzed PHPS material, suggesting that the catalyzed material is cured to a greater degree than the uncatalyzed material. At higher cure temperatures (e.g., 400 oC), the difference in elastic modulus between the uncatalyzed material (Ex. 1D) and the catalyzed material (Ex. 2D) is minimal, suggesting that the catalyst is less effective and/or not necessary to accelerate curing at these higher temperatures.

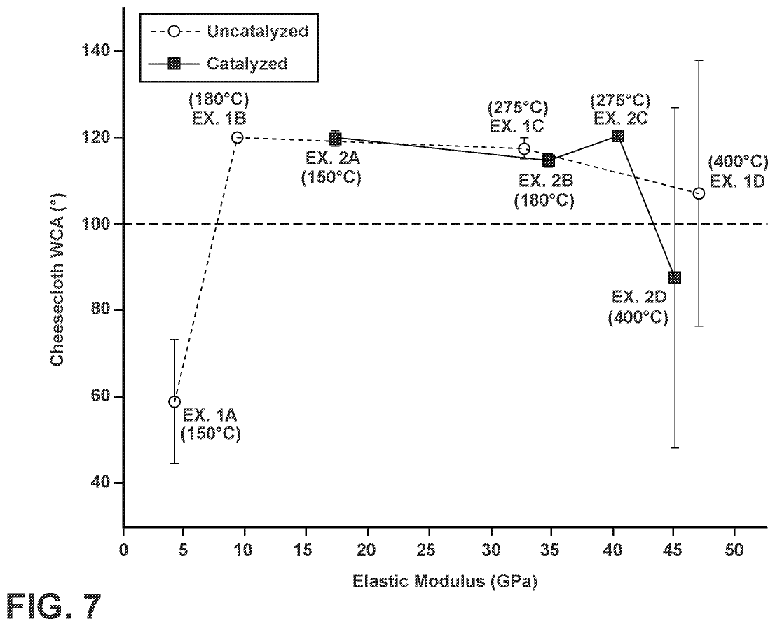

FIG. 7 is a plot showing the Cheesecloth Abrasion Test results of FIG. 5 (after 200,000 cycles) as a function of the elastic modulus data of the cured uncatalyzed and catalyzed PHPS coatings of Ex. 1A-D and Ex. 2A-D of FIG. 6. As shown in FIG. 7, Ex. 1A (uncatalyzed PHPS, cured at 150 oC) exhibited a low elastic modulus and also did not show an improvement in abrasion performance of the ETC coating, as indicated by the water contact angle (WCA) of less than 100 degrees after 200,000 cycles. Ex. 1D (uncatalyzed, cured at 400 oC) and Ex. 2D (catalyzed, cured at 400 oC) both exhibited a high elastic modulus, but also had an inconsistent effect on the abrasion performance of the ETC coating, as indicated by the variation in the WCA, including angles of less than 100 degrees.

In contrast, Ex. 1B-C and Ex. 2A-C, which exhibited an elastic modulus within the range of from about 9 GPa to about 40 GPa, also exhibited an improvement in the abrasion performance of the ETC coating, as indicated by WCA values of greater than 100 degrees. The data in FIG. 7 suggests that there is an optimal elastic modulus range for the cured PHPS coating that results in an improvement in abrasion performance of the ETC coating formed on these PHPS coatings. While not wishing to be limited by any theory, it is posited that the optimal elastic modulus range corresponds to a PHPS coating that is sufficiently compliant to offer some abrasion performance enhancement while also sufficiently cured to not be degraded during the abrasion test.

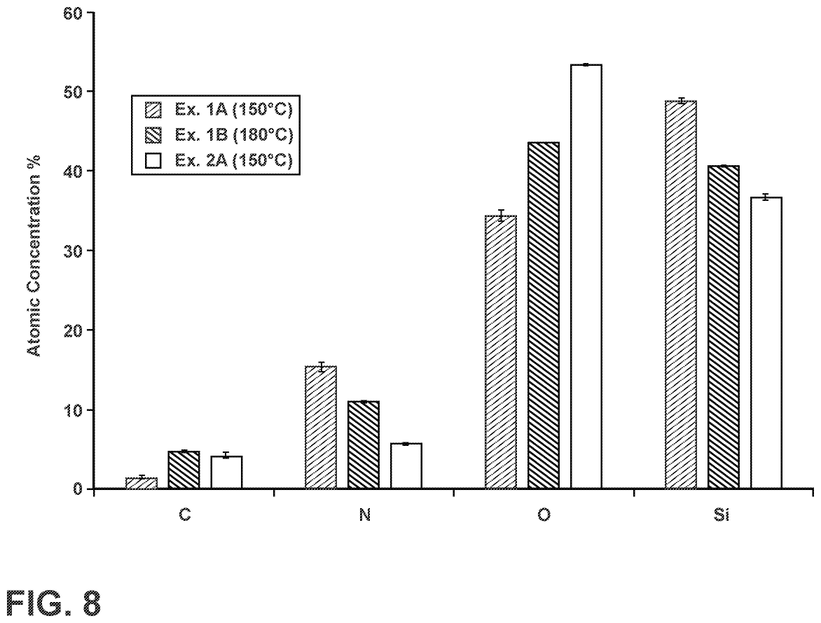

FIG. 8 illustrates the surface composition of several of the examples, Ex. 1A, Ex. 1B, and Ex. 2A, as measured by X-ray Photoelectron Spectroscopy (XPS). The surface composition is of the top 10 nm of the PHPS coating (prior to deposition of the ETC coating). The results show that measurable amounts of nitrogen are still present on the surface of uncatalyzed and catalyzed samples and indicate that the PHPS coating still includes measurable amounts of nitrogen at the surface that is distinct from silica.

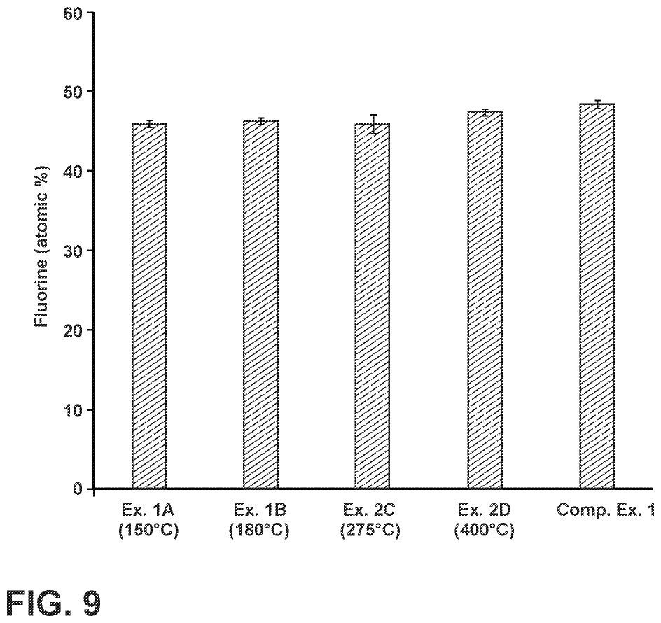

FIG. 9 illustrates the surface concentration of fluorine for several examples, Ex.1A, Ex. 1B, Ex. 2C, and Ex. 2D, and a comparative control, Comp. Ex. 1, as measured by X-ray Photoelectron Spectroscopy (XPS), prior to abrasion testing. Comp. Ex. 1 includes an ETC coating deposited on an anti-reflective coating supported on a glass sample prepared in the same manner as described above for Ex. 1A-D and Ex. 2A-D. The surface concentration of fluorine can be used as an indication of the amount of ETC coating present. The data in FIG. 9 indicates that prior to abrasion testing, there is little difference in the amount of ETC coating present on the surface of Ex.1A, Ex. 1B, Ex. 2C, and Ex. 2D and the Comp. Ex. 1, suggesting that the differences in abrasion performance are not due to a difference in the amount of ETC coating present on the surface.

All X-ray Photoelectron Spectroscopy (XPS) measurements were performed with a Physical Electronics PHI Quantum 2000 XPS instrument equipped with monochromatized Al Kα radiation and used a combination of low energy electrons and Argon ions for charge neutralization. During the XPS measurements, an approximately 100 micrometer wide monochromatized Al Kα beam with a beam energy of approximately 25 Watts was rastered over the probed area which was 1 mm by 0.5 mm in size. For each example, 2 such areas were measured. The results reported in FIGS. 8 and 9 are the average compositions for both areas and the error bars are the standard deviations. Data collection parameters were optimized to minimize effects of beam damage that can be significant for fluorinated coatings. The pass energy of the spectrometer was set to a value of 46.95 eV with a step size of 0.1 eV/step and dwell time of 50 milliseconds per step. The core levels monitored during the XPS measurements are shown as follows in the order they were measured and the number of scans that each core level was measured appears in parenthesis: F 1s (1 scan), O 1s (2 scans), Si 2p (3 scans), C 1s (3 scans), and N 1s (3 scans). The data analysis was performed using the MultiPak software package (Version 9.4.0.7) provided and sold by Physical Electronics (copyrighted by Ulvac-phi, Incorporated 1994-2011). During analysis, the energy scale was referenced to the C-C/C-H peak of hydrocarbons set at the commonly accepted value of 284.8 eV. Compositional analysis was performed using the atomic sensitivity factors provided in the version of MultiPak software cited above.

Table 2 below illustrates examples of intermediate coatings made using a hydrogen silsesquioxane (HSQ) material according to the present disclosure. Examples 3A, 3B, 3C, 3D, and 3E (“Ex. 3A,” “Ex. 3B,” “Ex. 3C,” “Ex. 3D,” and “Ex. 3E”) included HSQ deposited on an anti-reflective coating supported on a glass substrate and cured according to the conditions listed in Table 2. Ex. 3A-E were all prepared by spin coating an HSQ solution (with or without catalyst) onto a plasma treated anti-reflective coating on a glass substrate. To prepare each sample, a solution of 1% by volume (%v/v) HSQ in Novec™ HFE 7200 engineered fluid (available from 3M™) was spin-coated at 1200 rpm for 30 seconds. For Ex. 3A and 3B, a 10% v/v solution of aminopropyl trialkoxysilane was then spin-coated at 600 rpm for 30 seconds. For Ex. 3C and 3D, a 10% v/v solution of hexylamine in ethanol was then spin-coated at 600 rpm for 30 seconds. Ex. 3E did not include catalyst. All samples were then cured at the conditions indicated in Table 2. After curing, an ETC coating was formed on the samples. Each sample was plasma treated, followed by spray coating of a 0.6% v/v solution of a modified perfluoropolyether (PFPE) silane. The modified PFPE silane was Optool UD509, available from Daikin America, Inc. and was dissolved in Novec™ HFE 7200 engineered fluid, available from 3M™. The samples were then cured again at 150 oC to form the ETC coating. Samples cured at high humidity conditions were placed in a closed container with a small petri dish filled with water in the container to generate water vapor; the relative humidity in the container was estimated to be at least 80%. Low humidity conditions correspond to ambient humidity, which was estimated to be about 40-50% relative humidity.

TABLE 2
Example Uncatalyzed and Catalyzed Cured HSQ Coatings

| | | Cure Conditions | | |
|---|---|---|---|---|
| Example | Catalyst | Temperature | Humidity | Time |
| Ex. 3A | aminopropyl | 150° C. | High | 30 min. |
| | trialkoxysilane | | | |
| Ex. 3B | aminopropyl | 150° C. | Low | 30 min. |
| | trialkoxysilane | | | |
| Ex. 3C | hexylamine | 150° C. | High | 30 min. |
| Ex. 3D | hexylamine | 150° C. | Low | 30 min. |
| Ex. 3E | none | 150° C. | Low | 30 min. |

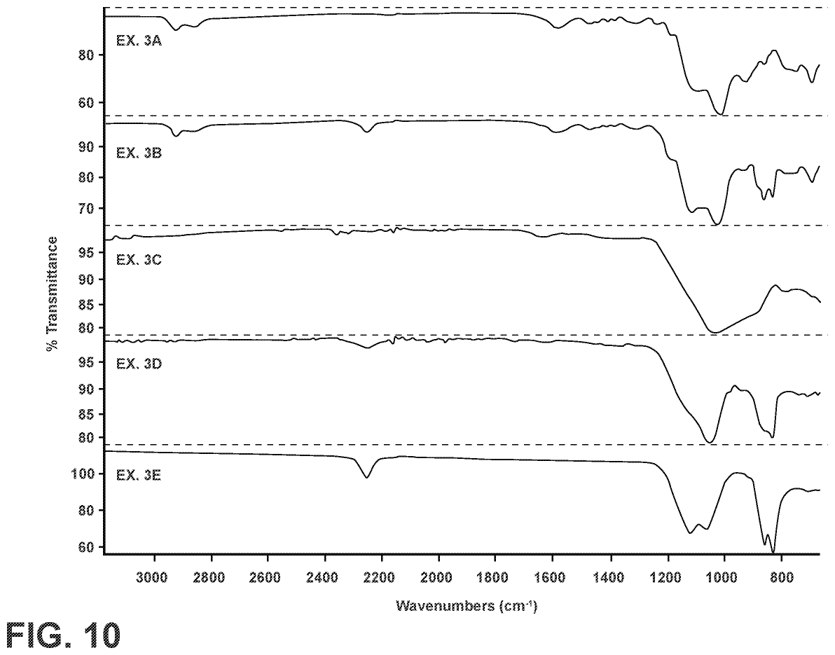

FIG. 10 illustrates the FTIR spectra of the cured HSQ coatings of Ex. 3A-E prior to depositing the ETC coating. The data in FIG. 10 shows that curing an uncatalyzed HSQ material (Ex. 3E) at a low temperature of 150 oC produces an incompletely cured coating, as indicated by the presence of a relatively large Si—H peak in the FTIR spectrum (˜2250 cm−1). The intensity of the Si—H is diminished when the HSQ material is cured in the presence of a catalyst in both high and low humidity conditions, as shown by the spectra for Ex. 3A-D in FIG. 10. The reduced intensity of the Si—H peak at 2250 cm−1 for Ex. 3A-D suggests that a suitable catalyst can catalyze the curing of HSQ to increase the degree of curing at low temperatures, such as 150 oC.

Without wishing to be limited by any theory, typically, high temperatures (e.g., about 350 oC to 450 oC) are required to thermally cure HSQ to redistribute the HSQ cage structure into an SiOx network on the sample surface. The high cure temperatures to convert the HSQ cage structure into an amorphous SiOx network are believed to be based at least in part on the high activation energy needed for bond rearrangement. However, the Si—H bonds in the HSQ cage can be converted to silanols in the presence of some aqueous bases, such as aminopropyl trialkoxysilane and hexylamine. Once the Si—H to Si—OH conversion occurs, the temperature needed to condense two Si—OH groups to give an Si—O—Si structure (with water as a by-product), is much lower. The FTIR spectra in FIG. 10 show that the catalyzed HSQ samples Ex. 2A-D are cured to a much greater extent than the uncatalyzed HSQ sample Ex. 2D at a curing temperature of 150 oC, as evidenced by the decreased intensity of the Si—H peak at 2250 cm−1. It is believed that the reaction pathway utilized during catalyzed curing of HSQ requires the presence of moisture. However, as the reaction progresses, the condensation of silanols generates additional water that can be utilized in converting unreacted Si—H groups. The FTIR spectra peaks around 800-900 cm−1 and 1150 cm−1 for Ex. 2A and 2C (high humidity) compared to Ex. 2B and 2D (low humidity) suggest that an increase in SiOx network formation occurs during curing of the HSQ at high humidity compared to low humidity conditions.

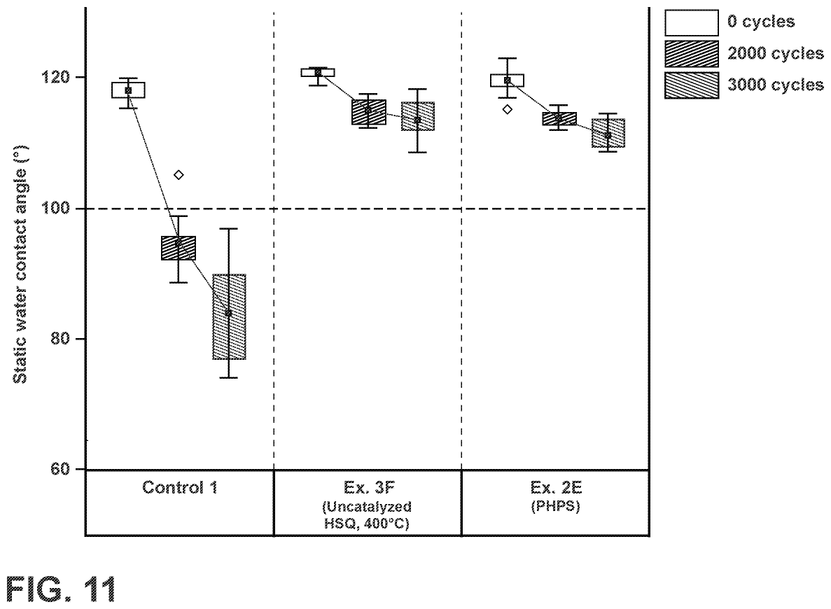

FIG. 11 illustrates the results of a Steel Wool Abrasion Test for a control sample (“Control 1”), a sample including a high temperature cured, uncatalyzed HSQ coating (“Ex. 3F”), and a sample including a PHPS intermediate coating according to the present disclosure (“Ex. 2E”). Each sample included a substrate consisting of an anti-reflective coating disposed on a glass substrate and included an ETC coating prepared as described above with respect to Ex. 3A-E. The Control included an ETC coating formed on an anti-reflective coating disposed on a glass substrate. Ex. 3F included an ETC coating formed on an uncatalyzed HSQ coating. Ex. 3F was prepared by spin-coating a 1% v/v solution of HSQ in Novec™ HFE 7200 on a glass substrate at 1200 rpm for 30 seconds and then curing at 400 oC for 30 min. Ex. 2E included an ETC coating formed on a PHPS coating supported on a glass substrate. The PHPS coating of Ex. 2E was prepared by spin coating a 1% Durazane 2850 solution (in di-n-butyl ether) at 1000 rpm and then curing at 150 oC for 30 minutes.

The water contact angle for each sample was measured on the cured ETC coating prior to and after 2,000 or 3,000 reciprocating cycles under a 1 kg load. As shown in FIG. 11, the Control, which did not include an intermediate coating (i.e., no SiOx coating) between the substrate and the ETC coating, exhibited a decrease in the water contact angle to less than 100 degrees after 2,000 and 3,000 cycles. Ex. 3F included an ETC coating deposited on an SiOx network formed from a high temperature cure (400 oC) of HSQ. The data in FIG. 11 shows that Ex. 3F exhibited an improvement in the abrasion resistance of the ETC coating after 2,000 and 3,000 cycles compared to the Control. After both 2,000 and 3,000 cycles, Ex. 3F exhibited a water contact angle of greater than 100 degrees and in several cases greater than 110 degrees. However, as discussed above, in some applications, curing at 400 oC to form an intermediate coating to provide an SiOx network is not feasible due to the potential effect on the optical properties of other materials present in the sample (e.g., some anti-reflective coatings). However, the data for Ex. 2E, which included a PHPS material cured at a low temperature to form an SiOx network, exhibited an improvement in the abrasion resistance of the ETC coating after 2,000 and 3,000 cycles compared to the Control. The data in FIG. 11 indicates that the materials and processes of the present disclosure can provide a route for obtaining an improvement in abrasion resistance of an ETC coating that is at least comparable to that obtained for a high temperature cured HSQ material at low curing temperatures that are less likely to affect the optical properties of other materials present in the sample.

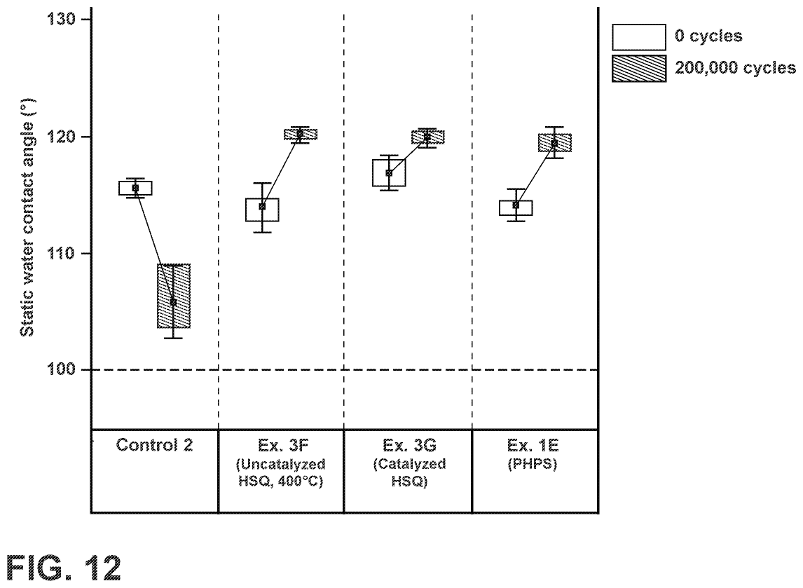

FIG. 12 illustrates the result of a Cheesecloth Abrasion Test for a control sample (“Control 2”), a sample including a high temperature cured, uncatalyzed HSQ coating (“Ex. 3F”), and two samples including an intermediate coating according to the present disclosure (“Ex. 1E” and “Ex. 3G”). Each sample included a glass substrate having an anti-reflective coating. The Control 2 sample included an ETC coating disposed directly on the anti-reflective coating. Ex. 3F included an intermediate HSQ coating between the anti-reflective coating and the ETC coating. The HSQ coating for Ex. 3F was formed by spin-coating a 1% v/v solution of HSQ in Novec™ HFE 7200 onto the substrate at 1200 rpm for 30 seconds and then at 400 oC for 30 min. (in the absence of a catalyst). Ex. 1E included a PHPS intermediate coating between the anti-reflective coating and the ETC coating that was formed by curing PHPS at a temperature of 180 oC for 30 min. Ex. 3G included an HSQ intermediate coating between the anti-reflective coating and the ETC coating. The HSQ coating for Ex. 3G was formed by spin-coating a 1% v/v solution of HSQ in Novec™ HFE 7200 at 1200 rpm for 30 seconds, followed by spin-coating a 10% v/v solution of hexylamine in ethanol at 600 rpm for 30 seconds. The sample was then cured at 150 oC for 30 minutes at high humidity. The ETC coating for each sample was formed by first plasma treating the surface, followed by spray coating of a 0.6% by volume (%v/v) solution of a modified perfluoropolyether (PFPE) silane. The modified PFPE silane was Optool UD509, available from Daikin America, Inc. and was dissolved in Novec™ HFE 7200 engineered fluid, available from 3M™. The samples were then cured at 150 oC to form the ETC coating.

As shown in FIG. 12, both the low temperature cure PHPS and HSQ intermediate coating samples (Ex. 1E and 3G, respectively) exhibited an improvement in abrasion resistance after 200,000 cycles compared to the control sample, Control 2. The low temperature cure PHPS and HSQ intermediate coating samples (Ex. 1E and 3G, respectively) also exhibited a similar or improved abrasion resistance compared to the high temperature cured HSQ example (Ex. 3F).

The following non-limiting embodiments are encompassed by the present disclosure. To the extent not already described, any one of the features of the following embodiments may be combined in part or in whole with features of any one or more of the other embodiments of the present disclosure to form additional embodiments, even if such a combination is not explicitly described.

According to a first embodiment of the present disclosure, an article comprises: a glass, glass-ceramic, or ceramic substrate having a primary surface; an anti-reflective coating disposed over the primary surface; an intermediate coating comprising a cured polysilazane or a cured silsesquioxane material disposed over the anti-reflective coating; and an easy-to-clean (ETC) coating comprising a fluorinated material disposed directly on the intermediate coating, and wherein the intermediate coating has an elastic modulus of from about 9 GPa to about 40 GPa.

According to a second embodiment of the present disclosure, the article of embodiment 1, wherein the ETC coating has a water contact angle of ≥100 degrees after being subjected to 2000 reciprocating cycles under a load of 1 kg according to a Steel Wool Abrasion Test.

According to a third embodiment of the present disclosure, the article of embodiment 1 or embodiment 2, wherein the ETC coating has a water contact angle of >100 degrees after being subjected to 200,000 reciprocating cycles under a load of 750 grams according to a Cheesecloth Abrasion Test.

According to a fourth embodiment of the present disclosure, the article of any one of embodiments 1-3, wherein the intermediate coating comprises a perhydropolysilazane or a polysilazane substituted with one or more organic moieties.

According to a fifth embodiment of the present disclosure, the article of any one of embodiments 1-3, wherein the intermediate coating comprises a polyhedral oligomeric silsesquioxane having the formula (RSiO3/2)n, where R is a hydrogen or an organic moiety.

According to a sixth embodiment of the present disclosure, an article comprises: a glass, glass-ceramic, or ceramic substrate having a primary surface; an anti-reflective coating disposed over the primary surface; an intermediate coating comprising a cured polysilazane or a cured silsesquioxane material disposed over the anti-reflective coating; and a polymer coating disposed directly on the intermediate coating, and wherein the polymer coating has a water contact angle of >100 degrees after being subjected to 200,000 reciprocating cycles under a load of 750 grams according to a Cheesecloth Abrasion Test.

According to a seventh embodiment of the present disclosure, the article of embodiment 6, wherein the polymer coating has a water contact angle of ≥100 degrees after being subjected to 2000 reciprocating cycles under a load of 1 kg according to a Steel Wool Abrasion Test.

According to an eighth embodiment of the present disclosure, the article of embodiment 6 or embodiment 7, wherein the intermediate coating has an elastic modulus of from about 9 GPa to about 40 GPa.

According to a ninth embodiment of the present disclosure, the article of any one of embodiments 6-8, wherein the intermediate coating comprises a perhydropolysilazane or a polysilazane substituted with one or more organic moieties.

According to a tenth embodiment of the present disclosure, the article of any one of embodiments 6-8, wherein the intermediate coating comprises a polyhedral oligomeric silsesquioxane having the formula (RSiO3/2)n, where R is a hydrogen or an organic moiety.

According to an eleventh embodiment of the present disclosure, a method of manufacturing an article comprises: depositing a solution on an anti-reflective coating disposed on a primary surface of a glass, glass-ceramic, or ceramic substrate, the solution comprising a polysilazane or a silsesquioxane; depositing a fluorinated material directly on the deposited solution; curing the polysilazane or the silsesquioxane at a temperature of about 300 oC or less to form an intermediate coating, wherein the curing occurs one of prior to or subsequent to the step of depositing a fluorinated material; and curing the fluorinated material to form an easy-to-clean (ETC) coating disposed directly on the intermediate coating.

According to a twelfth embodiment of the present disclosure, the method of embodiment 11, wherein the step of curing the polysilazane or the silsesquioxane occurs prior to the step of depositing a fluorinated material, and wherein the step of curing the fluorinated material comprises heating the article subsequent to the step of curing the polysilazane or silsesquioxane.

According to a thirteenth embodiment of the present disclosure, the method of embodiment 11, wherein the step of curing the polysilazane or the silsesquioxane occurs subsequent to the step of depositing a fluorinated material, and wherein the fluorinated material cures during the step of curing the polysilazane or the silsesquioxane.

According to a fourteenth embodiment of the present disclosure, the method of any one of embodiments 11-13, wherein the step of curing the polysilazane or the silsesquioxane comprises curing the polysilazane or the silsesquioxane to form an intermediate coating having an elastic modulus of from about 9 GPa to about 40 GPa.

According to a fifteenth embodiment of the present disclosure, the method of any one of embodiments 11-14, wherein the ETC coating has a water contact angle of ≥100 degrees after being subjected to 2000 reciprocating cycles under a load of 1 kg according to a Steel Wool Abrasion Test.

According to a sixteenth embodiment of the present disclosure, the method of any one of embodiments 11-15, wherein the ETC coating has a water contact angle of >100 degrees after being subjected to 200,000 reciprocating cycles under a load of 750 grams according to a Cheesecloth Abrasion Test.

According to a seventeenth embodiment of the present disclosure, the method of any one of embodiments 11-16, wherein the intermediate coating comprises a perhydropolysilazane or a polysilazane substituted with one or more organic moieties.

According to a eighteenth embodiment of the present disclosure, the method of any one of embodiments 11-16, wherein the intermediate coating comprises a polyhedral oligomeric silsesquioxane having the formula (RSiO3/2)n, where R is a hydrogen or an organic moiety.

According to a nineteenth embodiment of the present disclosure, the method of any one of embodiments 11-18, wherein the step of curing the polysilazane or the silsesquioxane comprises curing at a temperature of about 200 oC or less.

According to a twentieth embodiment of the present disclosure, the method of any one of embodiments 11-19, wherein the intermediate coating solution further comprises a catalyst adapted to catalyze the polysilazane or the silsesquioxane during the step of curing.

Many variations and modifications may be made to the above-described embodiments of the disclosure without departing substantially from the spirit and various principles of the disclosure. All such modifications and variations are intended to be included herein within the scope of this disclosure and protected by the following claims.

To the extent not already described, the different features of the various aspects of the present disclosure may be used in combination with each other as desired. That a particular feature is not explicitly illustrated or described with respect to each aspect of the present disclosure is not meant to be construed that it cannot be, but it is done for the sake of brevity and conciseness of the description. Thus, the various features of the different aspects may be mixed and matched as desired to form new aspects, whether or not the new aspects are expressly disclosed.

What is claimed is:

1. An article, comprising:
a glass, glass-ceramic, or ceramic substrate having a primary surface;
an anti-reflective coating disposed over the primary surface;
an intermediate coating comprising a cured polysilazane or a cured silsesquioxane material disposed over the anti-reflective coating; and
an easy-to-clean (ETC) coating comprising a fluorinated material disposed directly on the intermediate coating, and
wherein the intermediate coating has an elastic modulus of from about 9 GPa to about 40 GPa.

2. The article of claim 1, wherein the ETC coating has a water contact angle of ≥100 degrees after being subjected to 2000 reciprocating cycles under a load of 1 kg according to a Steel Wool Abrasion Test.

3. The article of claim 1, wherein the ETC coating has a water contact angle of >100 degrees after being subjected to 200,000 reciprocating cycles under a load of 750 grams according to a Cheesecloth Abrasion Test.

4. The article of claim 1, wherein the intermediate coating comprises a perhydropolysilazane or a polysilazane substituted with one or more organic moieties.

5. The article of claim 1, wherein the intermediate coating comprises a polyhedral oligomeric silsesquioxane having the formula (RSiO_{3/2})ₙ, where R is a hydrogen or an organic moiety.

6. An article, comprising:
a glass, glass-ceramic, or ceramic substrate having a primary surface;
an anti-reflective coating disposed over the primary surface;
an intermediate coating comprising a cured polysilazane or a cured silsesquioxane material disposed over the anti-reflective coating; and
a polymer coating disposed directly on the intermediate coating, and
wherein the polymer coating has a water contact angle of >100 degrees after being subjected to 200,000 reciprocating cycles under a load of 750 grams according to a Cheesecloth Abrasion Test.

7. The article of claim 6, wherein the polymer coating has a water contact angle of ≥100 degrees after being subjected to 2000 reciprocating cycles under a load of 1 kg according to a Steel Wool Abrasion Test.

8. The article of claim 6, wherein the intermediate coating has an elastic modulus of from about 9 GPa to about 40 GPa.

9. The article of claim 6, wherein the intermediate coating comprises a perhydropolysilazane or a polysilazane substituted with one or more organic moieties.

10. The article of claim 6, wherein the intermediate coating comprises a polyhedral oligomeric silsesquioxane having the formula (RSiO_{3/2})ₙ, where R is a hydrogen or an organic moiety.

11. A method of manufacturing an article, comprising:
depositing a solution on an anti-reflective coating disposed on a primary surface of a glass, glass-ceramic, or ceramic substrate, the solution comprising a polysilazane or a silsesquioxane;
depositing a fluorinated material directly on the deposited solution;
curing the polysilazane or the silsesquioxane at a temperature of about 300° C. or less to form an intermediate coating, wherein the curing occurs one of prior to or subsequent to the step of depositing a fluorinated material; and
curing the fluorinated material to form an easy-to-clean (ETC) coating disposed directly on the intermediate coating.

12. The method of claim 11, wherein the step of curing the polysilazane or the silsesquioxane occurs prior to the step of depositing a fluorinated material, and wherein the step of curing the fluorinated material comprises heating the article subsequent to the step of curing the polysilazane or silsesquioxane.

13. The method of claim 11, wherein the step of curing the polysilazane or the silsesquioxane occurs subsequent to the step of depositing a fluorinated material, and wherein the fluorinated material cures during the step of curing the polysilazane or the silsesquioxane.

14. The method of claim 11, wherein the step of curing the polysilazane or the silsesquioxane comprises curing the polysilazane or the silsesquioxane to form an intermediate coating having an elastic modulus of from about 9 GPa to about 40 GPa.

15. The method of claim 11, wherein the ETC coating has a water contact angle of ≥100 degrees after being subjected to 2000 reciprocating cycles under a load of 1 kg according to a Steel Wool Abrasion Test.

16. The method of claim 11, wherein the ETC coating has a water contact angle of >100 degrees after being subjected to 200,000 reciprocating cycles under a load of 750 grams according to a Cheesecloth Abrasion Test.

17. The method of claim 11, wherein the intermediate coating comprises a perhydropolysilazane or a polysilazane substituted with one or more organic moieties.

18. The method of claim 11, wherein the intermediate coating comprises a polyhedral oligomeric silsesquioxane having the formula (RSiO_{3/2})ₙ, where R is a hydrogen or an organic moiety.

19. The method of claim 11, wherein the step of curing the polysilazane or the silsesquioxane comprises curing at a temperature of about 200° C. or less.

20. The method of claim 11, wherein the intermediate coating solution further comprises a catalyst adapted to catalyze the polysilazane or the silsesquioxane during the step of curing.
